(19) United States
(12) Patent Application Publication
(10) Pub. No.: US 2011/0315466 A1
(43) Pub. Date: Dec. 29, 2011

(54) Seatbelt safety release

(76) Inventor: Albert C. Ammons, Chicago, IL (US)

(21) Appl. No.: 13/134,366

(22) Filed: Jun. 6, 2011

Related U.S. Application Data
(60) Provisional application No. 61/398,437, filed on Jun. 25, 2010.

(51) Int. Cl. B60R 22/32

(52) U.S. Cl. 180/268

(57) ABSTRACT

The Seatbelt Safety Release is an electronic assembly that disengages the seat belt lock following an impact. The Seatbelt Safety Release is installed directly into the seatbelt locking bay, and is equipped to automatically release the belt five seconds after impact. This action is achieved via a transmitting and receiving system, which constitutes the Seatbelt Safety Release device. The transmitter is a small electronic unit featuring a frequency generator, amplifier, internal antenna, and electrical/electronic components with respective circuitry encased within a durable plastic housing. Also enclosed within the plastic housing is a small replaceable battery that powers the unit. The receiver consists of a tuned frequency, receiver circuit, and replaceable battery. When a crash occurs, the transmitter unit generates and transmits a signal which transmission disengages the lock, freeing the motorist.

### CLAIM OF PRIORITY

This patent application claims priority under 35 USC 119 (e) (1) from U.S. Provisional Patent Application Ser. No. 61/398,437 filed Jun. 25, 2010, of common inventorship herewith entitled, “Seatbelt Safety Release.”

### FIELD OF THE INVENTION

The present invention pertains to the field of automotive safety devices, and more specifically to the field of seatbelt release devices.

### BACKGROUND OF THE INVENTION

The prior art has put forth several designs for seatbelt release devices. Among these are:

U.S. Pat. No. 4,574,911 to Lawrence A. North describes a seat belt buckle emergency release system that is electrically actuated after the vehicle has come to rest.

U.S. Pat. No. 4,162,715 to George Coulonbe describes an automatic releasing seat belt. Upon impact, the sensors operate a timer which disposes the solenoid into an activated condition releasing all of the belt mechanisms electrically coupled to it.

U.S. Pat. No. 5,181,738 to Shigeichi Shimizu describes an automatic seat belt unlocking device mechanically configured with a lock box structure, a mounting structure and a releasable device which is operably connected between the mounting structure and the locking lever.

None of these prior art references describe the present invention.

### SUMMARY OF THE INVENTION

It is an object of the present invention to provide an improved seatbelt release device.

### BRIEF DESCRIPTION OF THE DRAWINGS

FIG. 1 is an elevational angled perspective view of the device of the present invention in both the retracted and extended configurations.

FIG. 2 is a close-up right angled perspective view of a portion of the device of the present invention.

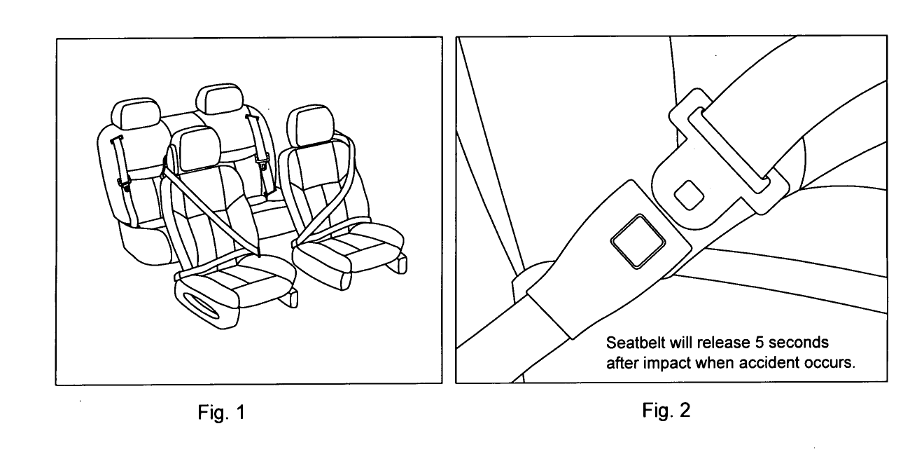

### DETAILED DESCRIPTION OF THE INVENTION

The most important and useful of all automotive safety devices is the common seat belt. Designed to restrain both drivers and passengers during a crash, seat belts are found in the vast majority of cars, buses and trucks on the road. During a crash, properly fastened safety belts distribute the forces of rapid deceleration over larger and stronger parts of a person's body, such as the hips, chest and shoulders. Stretching slightly to slow the body down and increase stopping distance, a properly buckled seat belt is crucial to the well being of those involved in minor fender benders and severe automobile crashes alike.

Although wearing a seat belt when traveling in a car, van or truck is a key factor in surviving an accident and is in fact, mandatory in most states, these safety implements present a drawback. In the event of an impact, there are times that the seat belt turns the motorist into a virtual prisoner. Impossible to release, the seat belt traps the occupants of the vehicle, making it difficult for them to escape the wrecked car and for rescue personnel to free them. It is an extremely scary, and potentially deadly, scenario when one is trapped in a burning vehicle or submerged in water and is unable to get to safety because of being trapped by a seat belt.

The present invention, hereinafter referred as the Seatbelt Safety Release is an electronic assembly that disengages the seat belt lock following an impact. The Seatbelt Safety Release is installed directly into the seatbelt locking bay, and is equipped to automatically release the belt five seconds after impact. This action is achieved via a transmitting and receiving system, which constitutes the Seatbelt Safety Release device. The transmitter is a small electronic unit featuring a frequency generator, amplifier, internal antenna, and electrical/electronic components with respective circuitry encased within a durable plastic housing. Also enclosed within the plastic housing is a small replaceable battery that powers the unit. The receiver consists of a tuned frequency, receiver circuit, and replaceable battery. When a crash occurs, the transmitter unit generates and transmits a signal. The companion receiving unit is tuned to the specific frequency generated by the transmitter unit. Upon reception of the signal generated by the transmitter, the circuitry in the receiver generate an ‘enable’ signal to a logic device, an ‘AND’ integrated circuit chip or comparable, which applies a voltage level to the seatbelt lock, causing the system to be activated. This action, in turn, disengages the lock, freeing the motorist. As such, the Seatbelt Safety Release saves many lives, regardless of the severity of the accident. Facilitating a motorist's own escape as well as easing the efforts of professional rescue personnel, the product of the current invention proves an ideal addition to any vehicle, whether car, truck, van, RV, SUV, bus, and airplane.

Although this invention has been described with respect to specific embodiments, it is not intended to be limited thereto and various modifications which will become apparent to the person of ordinary skill in the art are intended to fall within the spirit and scope of the invention as described herein taken in conjunction with the accompanying drawings and the appended claims.

1. A seatbelt release device, comprising an electronic assembly that disengages the seat belt lock following an impact, wherein the device is installed directly into the seatbelt locking bay, and is equipped to automatically release the belt five seconds after impact.

2. The device of claim 1 wherein the release is achieved by means of a transmitting and receiving system, wherein the transmitter is a small electronic unit featuring a frequency generator, amplifier, internal antenna, and electronic components having required circuitry encased within a durable plastic housing.

3. The device of claim 2 wherein the plastic housing also encloses a small replaceable battery that powers the unit.

4. The device of claim 2 wherein the receiver consists of a tuned frequency, receiver circuit, and replaceable battery so that when a crash occurs, the transmitter unit generates and transmits a signal and the receiving unit is tuned to the specific frequency generated by the transmitter unit, and whereupon reception of the signal generated by the transmitter, the circuitry in the receiver generate an ‘enable’ signal to a logic device, an ‘AND’ integrated circuit chip or comparable, which applies a voltage level to the seatbelt lock, causing the system to be activated, and wherein this applied voltage disengages the lock, freeing the motorist.
